(19) United States
(12) Patent Application Publication
(10) Pub. No.: US 2009/0051342 A1
(43) Pub. Date: Feb. 26, 2009

(54) BANDGAP REFERENCE CIRCUIT

(75) Inventors: YAN-HUA PENG, Miaoli (TW); UEI-SHAN UANG, Taichung (TW); CHIA-WEI CHANG, Taichung (TW)

Correspondence Address: WPAT, PC, 7225 BEVERLY ST., ANNANDALE, VA, 22003, US

(73) Assignee: FARADAY TECHNOLOGY CORPORATION, Hsinchu (TW)

(21) Appl. No.: 12/195,061

(22) Filed: Aug. 20, 2008

(30) Foreign Application Priority Data
Aug. 22, 2007 (TW) 096131130

(51) Int. Cl. G05F 3/16

(52) U.S. Cl. 323/313

(57) ABSTRACT

A bandgap reference circuit includes an input circuit having a first FET, a second FET, and a first resistor, wherein a first node is connected to the first FET having a first threshold voltage, the first resistor is connected between a second node and the second FET having a second threshold voltage; a mirroring circuit for controlling two output currents respectively derived from the first and second nodes, and maintaining the two output currents to a specific current ratio; and an operation amplifier connected to the first node, the second node of the input circuit, and the mirroring circuit, for controlling two voltages respectively at the first and second nodes of the input circuit to a specific voltage ratio; wherein the first FET and the second FET are both operating in the subthreshold region, the first threshold voltage is larger than the second threshold voltage, and the two output currents are independent of temperature.

### FIELD OF THE INVENTION

The present invention relates to a bandgap reference circuit, and more particularly to a bandgap reference circuit supplied by a low supply voltage.

### BACKGROUND OF THE INVENTION

As known in the art, a bandgap reference circuit provides a steady reference voltage (V_{ref}) that will not be varied by manufacturing process, temperature or the supply voltage. In the hybrid circuit field, the bandgap reference circuit is designed into many circuits such as voltage regulators, digital to analog converters or low drift amplifier.

Please refer to FIG. 1, which illustrates a conventional bandgap reference circuit implemented by PMOS FETs, PNP BJTs and an operation amplifier. Generally speaking, the bandgap reference circuit includes a mirroring circuit 12, an operation amplifier 15 and an input circuit 20. The mirroring circuit 12 comprises three PMOS FETs, M1, M2 and M3. In this example, M1, M2 and M3 have the same aspect ratio (W/L), and the gates of M1, M2 and M3 are connected to one another and the sources of M1, M2 and M3 are connected to a supply voltage (Vss). The drains of M1, M2 and M3 output current Iₓ, I_{y} and I_{z} respectively. Also, an output terminal of the operation amplifier 15 is connected to the gates of M1, M2 and M3 while a positive input terminal of the operation amplifier 15 is connected to the drain of M2 and a negative input terminal of the operation amplifier 15 is connected to the drain of M1. Furthermore, input circuit 20 comprises two PNP BJTs, Q1 and Q2. The area of Q1 is m times larger than that of Q2. The bases and collectors of Q1 and Q2 are connected to the ground to make Q1 and Q2 form diode connections. The emitter of Q2 is connected to the negative input terminal of the operation amplifier 15. A first resistor (R1) is connected between the emitter of Q1 and the positive of the operation amplifier 15. Furthermore, BJT Q3 having the same area with Q2 includes a bases and a collector connected to the ground. A second resistor (R2) is connected between an emitter of Q3 and a drain of M3 and the drain of M3 is capable of outputting the reference voltage (V_{ref}).

As shown in FIG. 1, since M1, M2 and M3 have the same aspect ratio, the current Iₓ, I_{y} and I_{z} outputted by the M1, M2 and M3 are the same. That is I_{x=I}_{y}=I_{z} - - - (1).

Further, under the premise that the operation amplifier 15 has an infinite gain, a voltage difference between the positive and negative input terminals of the operation amplifier 15 will be the same. That is V_{y}=Vₓ. Thus, R₁I_{y}+V_{EB1}=V_{EB2} - - - (2).

Since Q1 and Q2 form diode connections and the area of Q1 is m times larger than

$$Q 2 , {I}_{x} = {I}_{s} {e}^{\frac{{V}_{EB 2}}{{V}_{T}}} and {I}_{y} = {mI}_{s} {e}^{\frac{{V}_{EB 1}}{{V}_{T}}} ,$$

which derive V_{BE1}=V_{T} ln(I_{y}/mIₛ) - - - (3), and V_{BE2}=V_{T} ln(Iₓ/Iₛ) - - - (4) can be obtained; where the Iₛ is a saturation current of Q2 and the V_{T} is a thermal voltage. Finally, combining equations of (1), (2), (3) and (4), the current I_{y}=(1/R₁)V_{T} ln m - - - (5), and the reference voltage V_{ref}=(R₂/R₁)V_{T} ln m+V_{EB3} - - - (6) are obtained.

FIG. 2A is a diagram showing reference voltage (V_{ref}) generated from the components of the bandgap reference circuit. The voltage (V_{BE}) is generated by the base-emitter voltage generator 32; the thermal voltage (V_{T}) is generated by the thermal voltage generator 34; the thermal voltage (V_{T}) is multiplied by a temperature-independent scalar (K) 36; and the reference voltage (V_{ref}), according to Eq. (6), is derived from adding V_{BE} to V_{T} multiplied by K. That is, V_{ref}=V_{BE}+KV_{T}, where K=(R₂/R₁)ln m.

FIG. 2B is a sketch of V_{ref} versus temperature. Obviously, the voltage V_{BE} generated by the base-emitter voltage generator 32 is inversely proportional to temperature, that is, V_{BE} has a characteristic of negative-temperature coefficient. Conversely, the thermal voltage V_{T} generated by the thermal voltage generator 34 is proportional to temperature, that is, the thermal voltage V_{T} has a characteristic of positive-temperature coefficient. A zero temperature coefficient is accordingly obtained if V_{BE} is added to V_{T} multiplied by a constant K, in other words, the reference voltage (V_{ref}) is almost a constant at any temperature.

Generally, the forward bias voltage of a BJT transistor is about 0.83V at −40□, and the voltage drop between the supply voltage (Vss) and the input circuit 20 (that is, the mirroring circuit 12 and the operation amplifier 15) is at least 0.17V. In other words, to operate the bandgap reference circuit in FIG. 1 normally, the supply voltage (Vss) is at least 1V (0.83V+0.17V), that is, the supply voltage of the prior-art bandgap reference circuit is at least 1V.

With the development of the semiconductor fabrication process from 0.13 μm, 90 nm, 60 nm, and even to 45 nm, 30 nm, the operating voltage of analog ICs is accordingly decreasing. However, the relatively low operating voltage may affect the normal operation of the prior-art bandgap reference circuit.

In order to prevent the problem of the prior-art bandgap reference circuit must be operated in a relatively high supply voltage, the BIT transistors in the input circuit 20 can be replaced by the Schottky diodes having a lower forward bias voltage, it follows that the bandgap reference circuit can be operated in a relatively low supply voltage. Similarly, the BJT transistors in the input circuit 20 can be also replaced by the dynamic threshold MOS (DT MOS).

However, the fabrication process of the Schottky diode or the DT MOS is not compatible of the standard semiconductor fabrication process. That is, extra fabrication steps and the corresponding masks for the extra fabrication steps are required to the manufactures of the Schottky diode or the DT MOS in the standard semiconductor fabrication process.

FIG. 3A is a sketch showing the \sqrt{I_{D}}−V_{GS} characteristic of a MOSFET, where \sqrt{I_{D}} is the root value of the drain current and V_{GS} is the gate-source voltage of the MOSFET. Generally, the MOSFET is operating in the subthreshold region (or weak inversion region) when V_{GS} is less than a voltage V_{ON}; conversely, the MOSFET is operating in the strong inversion region when V_{GS} is greater than the voltage V_{ON}. FIG. 3B is a sketch showing the log(I_{D})−VGS characteristic for a MOSFET, where log(I_{D}) is the log value of the drain current. Obviously, log(I_{D}) is proportional to V_{GS} in the subthreshold region, in other words, the MOSFET behaves as a diode when the MOSFET is operating in the subthreshold region.

Therefore, to make all devices in the input circuit 20 compatible of the standard semiconductor fabrication process, conventionally the BJTs in the input circuit 20 are replaced by MOSFTSs operating in the subthreshold region, accordingly, the bandgap reference circuit can be operated by providing a relatively low supply voltage (Vss).

When MOSFET is operating in the subthreshold region, the drain current is given by:

$${I}_{D} ≅ {I}_{D 0} ( \frac{W}{L} ) exp ( \frac{{V}_{GS}}{ξ \cdot {V}_{T}} ) ,$$

where I_{D0} is a process-dependent parameter, V_{T} is the thermal voltage

$$( {V}_{T} = \frac{kT}{q} ) ,$$

and ξ is non-ideality factor and in the range of 1˜3.

FIG. 4 is a schematic diagram showing the configuration of a prior-art bandgap reference circuit constituted by PMOS transistors, NMOS transistors, and an operation amplifier. The bandgap reference circuit includes a mirroring circuit 42, an operation amplifier 45 and an input circuit 50. The mirroring circuit 42 comprises three PMOS FETs, M1, M2 and M3. In this example, M1, M2 and M3 have the same aspect ratio (W/L), and the gates of M1, M2 and M3 are connected to one another and the sources of M1, M2 and M3 are connected to a supply voltage (Vss). The drains of M1, M2 and M3 output current Iₓ, I_{y} and I_{z} respectively. Also, an output terminal of the operation amplifier 45 is connected to the gates of M1, M2 and M3 while a positive input terminal of the operation amplifier 45 is connected to the drain of M2 and a negative input terminal of the operation amplifier 45 is connected to the drain of M1. Furthermore, input circuit 50 comprises two NMOS FETs, M4 and M5. The aspect ratio of M4 is n times larger than that of M5. A gate and a drain of M4 are connected to each other and a source of M4 is connected to the ground. The same, a gate and a drain of M5 are connected to each other and a source of M5 is connected to the ground. Furthermore, the drain of M5 is connected to the negative input terminal of the operation amplifier 45. A first resistor (R1) is connected between the drain of M4 and the positive of the operation amplifier 45. Furthermore, M6 having the same aspect ratio with M5 includes a gate and a drain connected to each other and a source connected to the ground. A second resistor (R2) is connected between the drain of M6 and the drain of M3 and the drain of M3 is capable of outputting the reference voltage (V_{ref}).

As shown in FIG. 4, since M1, M2 and M3 have the same aspect ratio, the current Iₓ, I_{y} and I_{z} outputted by the M1, M2 and M3 are the same. That is Iₓ=I_{y}=I_{z} - - - (7).

Further, under the premise that the operation amplifier 45 has an infinite gain, a voltage difference between the positive and negative input terminals of the operation amplifier 45 will be the same. That is V_{y}=Vₓ. Thus, R₁I_{y}+V_{GS5}=V_{GS4} - - - (8).

Since M4 and M5 are operating in the subthreshold region and the aspect ratio of M4 is n times larger than M5,

$${I}_{x} = {I}_{D 0} ( \frac{W}{L} ) exp ( \frac{{V}_{GS 5}}{ξ \cdot {V}_{T}} )$$

and,

$${I}_{y} = {I}_{D 0} ( \frac{nW}{L} ) exp ( \frac{{V}_{GS 4}}{ξ \cdot {V}_{T}} ) ,$$

which derive

$${V}_{GS 5} = ξ \cdot {V}_{T} ln [ \frac{{I}_{x}}{{I}_{D 0} ( W / L )} ] , \qquad ( 9 )$$

and

$${V}_{GS 4} = ξ \cdot {V}_{T} ln [ \frac{{I}_{y}}{{I}_{D 0} ( nW / L )} ] , \qquad ( 10 )$$

can be obtained. Finally, combining equations of (7), (8), (9) and (10), the current I_{y}=(ξ·V_{T}/R₁)ln(n) - - - (11), and the reference voltage V_{ref}32 (R₂/R₁)ξ·V_{T} ln(n)+V_{GS6} - - - (12) are obtained.

Similarly, the reference voltage (V_{ref}), according to Eq. (12), is derived from a thermal voltage generator having a characteristic of positive-temperature coefficient and a gate-source voltage generator having a characteristic of negative-temperature coefficient. In other words, the reference voltage (V_{ref}) is almost a constant at any temperature.

According to the description in IEEE J. Solid-State Circuits, vol. 38, no. 1, pp. 151-154, 2003 and Integrated Circuit Design and Technology, 2006. ICICDT apos; 06. 2006 IEEE International Conference on Volume, Issue, 24-26 May 2006 Page(s): 1-4, the threshold voltage model built in MOSFET operating in the subthreshold region is:

$${V}_{TH} ≅ {V}_{TH} ( {T}_{0} ) + {K}_{T} ( \frac{T}{{T}_{0}} - 1 ) , \qquad ( 13 )$$

### Where K_{T}<0.

Moreover, gate-source voltage (V_{GS}), threshold voltage (V_{TH}), and temperature have a relationship of:

$${V}_{GS} ( T ) ≅ {V}_{TH} ( T ) + {V}_{OFF} + [ {V}_{GS} ( {T}_{0} ) - {V}_{TH} ( {T}_{0} ) - {V}_{OFF} ] \frac{T}{{T}_{0}} , \qquad ( 14 )$$

Where V_{OFF} is a corrective constant term of the threshold voltage between the weak inversion (subthreshold) region and the strong inversion region.

Combining equations of (13) and (14),

$${V}_{GS} ( T ) ≅ {V}_{GS} ( {T}_{0} ) + {K}_{G} ( \frac{T}{{T}_{0}} - 1 ) , \qquad ( 15 )$$

Where K_{G}<0 and K_{G}≅K_{T}+V_{GS}(T₀)−V_{TH}(T₀)−V_{OFF}, is obtained.

Observe Eqs. (13) and (15), both the threshold voltage (V_{TH}) and the gate-source voltage (V_{GS}) have negative-temperature coefficients; and observe Eq. (14), the gate-source voltage (V_{GS}) is a function of the threshold voltage (V_{TH}) and temperature.

Even the fabrication process of the bandgap reference circuit depicted in FIG. 4 is compatible of the standard semiconductor fabrication process, the threshold voltage may not be a constant due to the variation of characteristic parameters resulted in the deviation of fabrication process. For example, under the critical situations of a same semiconductor fabrication process, FETs can be categorized to slow-corner FETs (S corner), fast-corner FETs (F corner), and typical-corner FETs (T corner) in a standard semiconductor fabrication process. The S-corner FET is defined as the FET having a weakest and slowest drive strength performance among a batch of FETs manufactured by a same standard semiconductor fabrication process; the F-corner FET is defined as the FET having a strongest and fastest drive strength performance among a batch of FETs manufactured by a same standard semiconductor fabrication process; the T-corner FET is defined as the FET having a normal drive strength performance among a batch of FETs manufactured by a standard semiconductor fabrication process.

FIG. 5A is a diagram showing the threshold voltage versus the temperature for the S-corner FET, the F-corner FET, and the T-corner FET. The threshold voltage (V_{TH}) of the S-corner FET is about 625 mV when the S-corner FET is operating at −20□, and the threshold voltage (V_{TH}) is decreasing to 525 mV along with the temperature increasing to 100□; the threshold voltage (V_{TH}) of the T-corner FET is about 520 mV when the T-corner FET is operating at −20□, and the threshold voltage (V_{TH}) is decreasing to 425 mV along with the temperature increasing to 100□; the threshold voltage (V_{TH}) of the F-corner FET is about 420 mV when the F-corner FET is operating at −20□, and the threshold voltage (V_{TH}) is decreasing to 325 mV along with the temperature increasing to 100□.

From Eq. (14), the gate-source voltage (V_{GS}) is a function of the threshold voltage (V_{TH}) and temperature. Accordingly, different values of the reference voltage (V_{ref}) may be derived from the bandgap reference circuits if the bandgap reference circuits are constituted by S-corner FETs, F-corner FETs, or T-corner FETs, which are manufactured in a same semiconductor fabrication process.

FIG. 5B is a diagram showing the reference voltage (V_{ref}) versus the temperature, where the reference voltages (V_{ref}) are derived from the bandgap reference circuits respectively implemented by S-corner FETs, F-corner FETs, and the T-corner FETs. Obviously, the reference voltage (V_{ref}) derived from the bandgap reference circuit implemented by S-corner FETs is independent of temperature but the value is about 280 mV; the reference voltage (V_{ref}) derived from the bandgap reference circuit implemented by T-corner FETs is independent of temperature but the value is about 240 mV; the reference voltage (V_{ref}) derived from the bandgap reference circuit implemented by F-corner FETs is independent of temperature but the value is about 205 mV.

Because the reference voltage (V_{ref}) derived from the bandgap reference circuit depicted in FIG. 5 cannot be accurately remained at a constant and have a ±15% error due to the deviation resulted in the standard semiconductor fabrication process, developing a bandgap reference circuit capable of providing a constant reference voltage is the main purpose of the present invention.

### SUMMARY OF THE INVENTION

Therefore, the present invention provides a bandgap reference circuit that is compatible of the standard semiconductor fabrication process. The reference voltage derived from the bandgap reference circuit is independent of temperature and the deviation resulted in the semiconductor fabrication process.

The present invention provides a bandgap reference circuit including an input circuit having a first FET, a second FET, and a first resistor, wherein a first node is connected to the first FET having a first threshold voltage, the first resistor is connected between a second node and the second FET having a second threshold voltage; a mirroring circuit for controlling two output currents respectively derived from the first and second nodes, and maintaining the two output currents to a specific current ratio; and an operation amplifier connected to the first node, the second node of the input circuit, and the mirroring circuit, for controlling two voltages respectively at the first and second nodes of the input circuit to a specific voltage ratio; wherein the first FET and the second FET are both operating in the subthreshold region, the first threshold voltage is larger than the second threshold voltage, and the two output currents are independent of temperature.

Furthermore, the present invention provides a bandgap reference circuit, comprising an input circuit having a first FET, a second FET, and a load device, wherein a first node is connected to a first FET having a first threshold voltage, the load device is connected between a second node and the second FET having a second threshold voltage; a mirroring circuit; and, an operation amplifier connected to the mirroring circuit, for controlling the mirroring circuit according a voltage difference between the first node and the second node; wherein the mirroring circuit is capable of generating two output currents respectively derived from the first node and the second node by control of the operation amplifier and maintaining the two output currents to a specific current ratio, and the first FET and the second FET are both operating in the subthreshold region, the first threshold voltage is greater than the second threshold voltage, and the two output currents are independent of temperature.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic diagram showing the configuration of a prior-art bandgap reference circuit;

FIG. 2A is a diagram showing reference voltage (V_{ref}) generated from the components of the bandgap reference circuit;

FIG. 2B is a sketch of V_{ref} versus temperature;

FIG. 3A is a sketch showing the \sqrt{I_{D}}−V_{GS} characteristic of a MOSFET;

FIG. 3B is a sketch showing the log(I_{D})−V_{GS} characteristic for a MOSFET;

FIG. 4 is a schematic diagram showing the configuration of a prior-art bandgap reference circuit;

FIG. 5A is a diagram showing the threshold voltage versus the temperature for the S-corner FET, F-corner FET, and the T-corner FET;

FIG. 5B is a diagram showing the reference voltage (V_{ref}) versus the temperature, where the reference voltages (V_{ref}) are derived from the bandgap reference circuits respectively implemented by S-corner FET, F-corner FET, and the T-corner FET;

FIG. 6 is a schematic diagram showing the configuration of a bandgap reference circuit of the present invention;

FIG. 7A is a diagram showing the threshold-voltage-difference value (ΔV_{TH}(T)) of two S-corner FETs, F-corner FETs, and T-corner FETs versus the temperature, where the S-corner FETs, the F-corner FETs, and the T-corner FETs have a different threshold voltage V_{TH} due to the deviation resulted in the semiconductor fabrication process; and

FIG. 7B is a diagram showing the reference voltage (V_{ref}) versus the temperature, where the reference voltage is derived from the bandgap reference circuit implemented by the S-corner FETs, the F-corner FETs, or the T-corner FETs having different threshold voltages due to the deviation resulted in the semiconductor fabrication process.

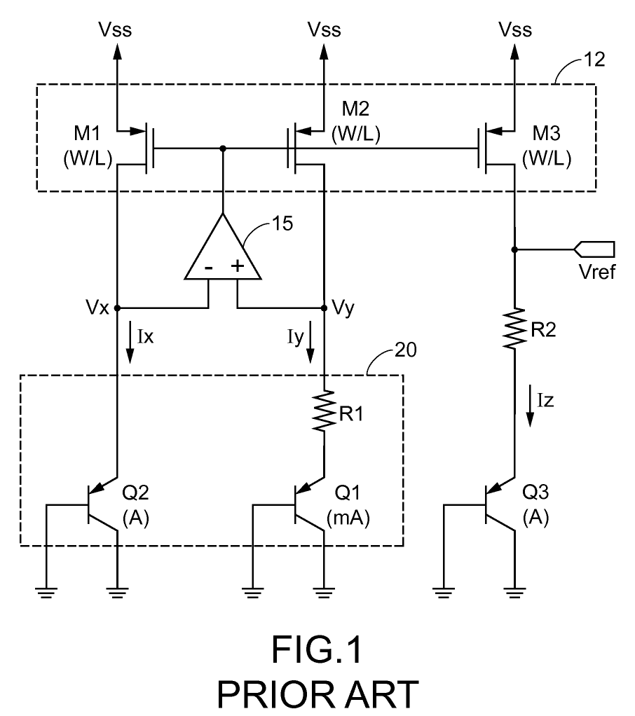

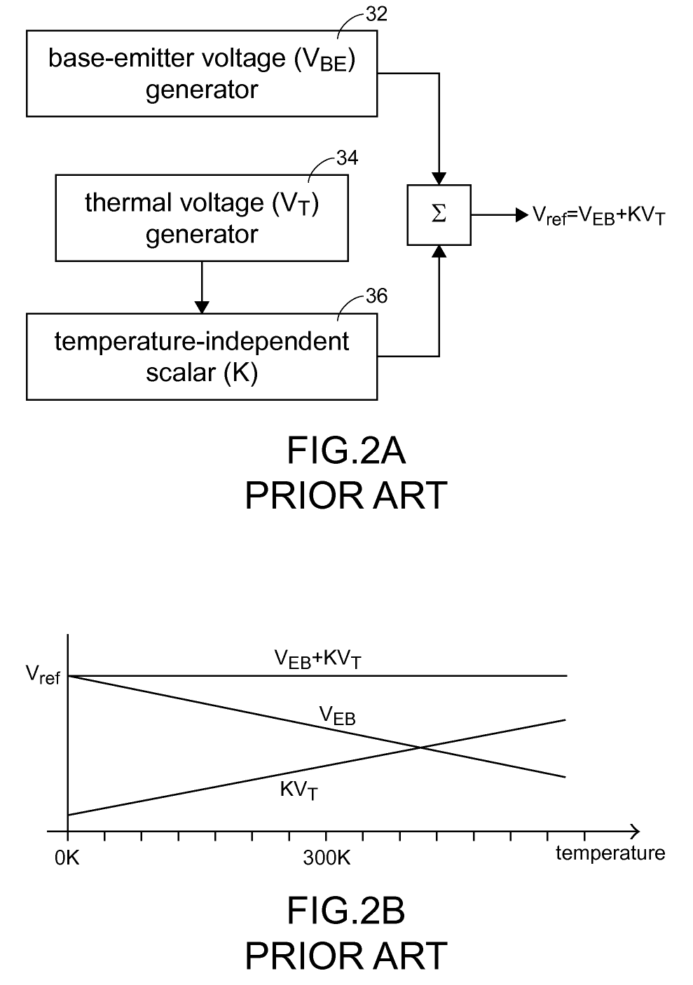

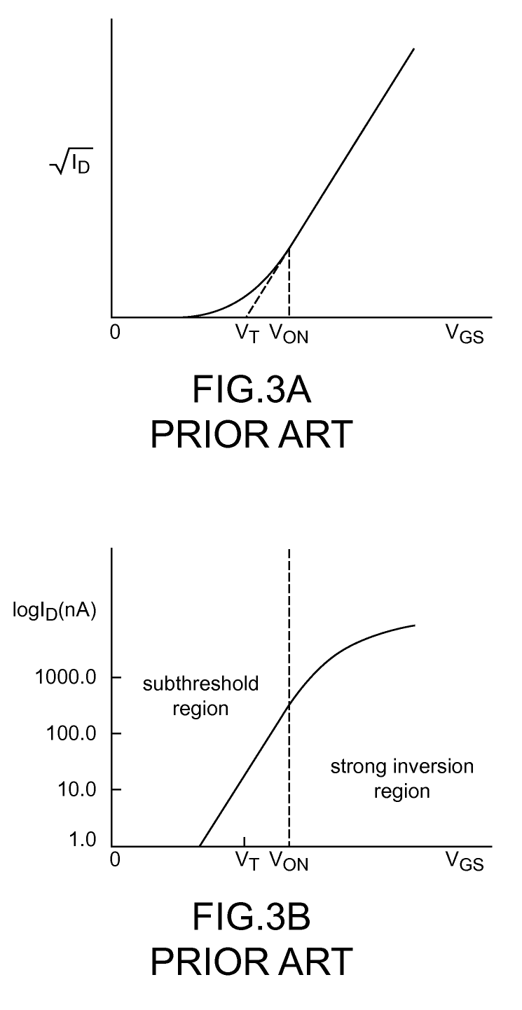

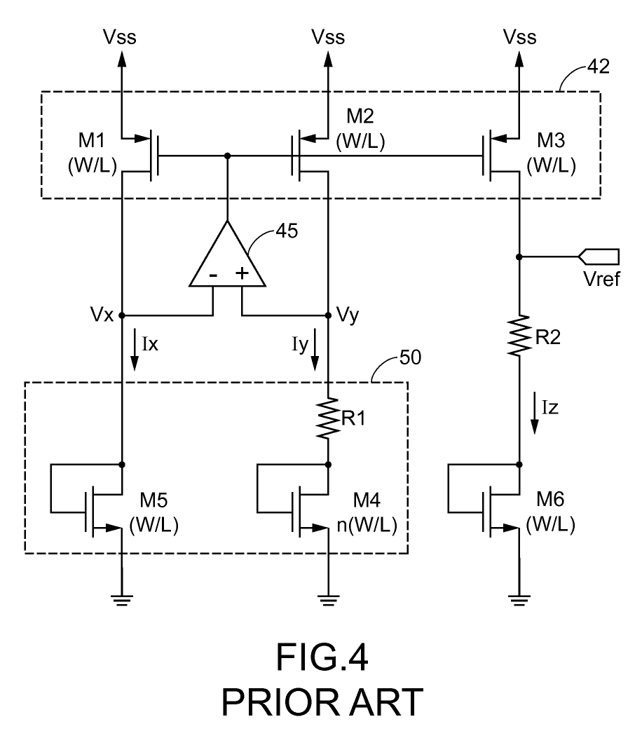

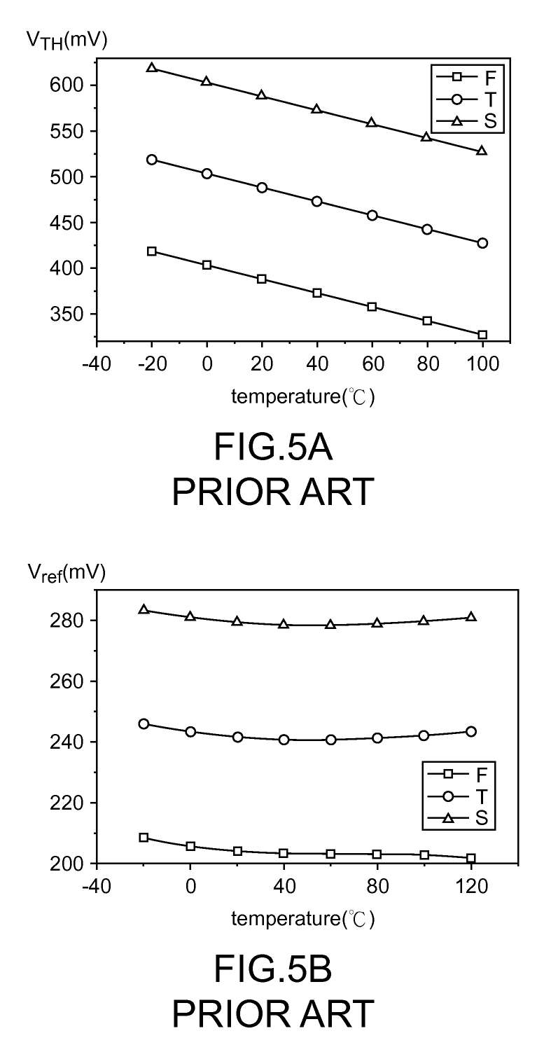

### DETAILED DESCRIPTION OF PREFERRED EMBODIMENTS

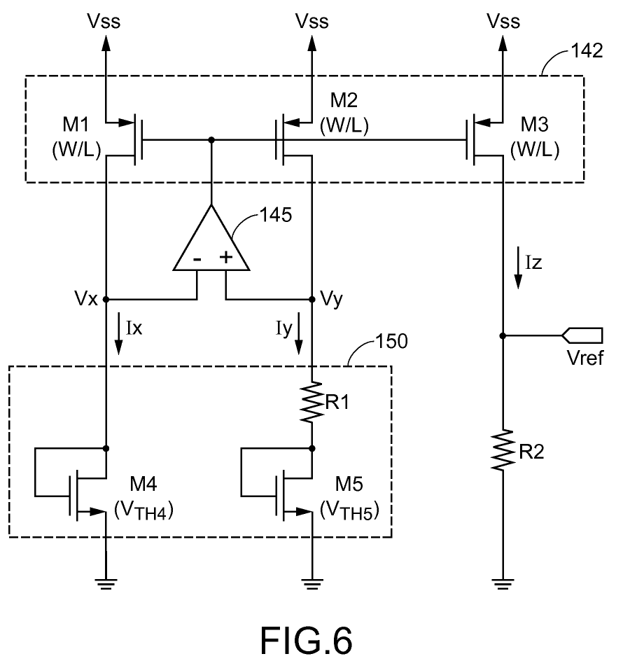

FIG. 6 is a schematic diagram showing the configuration of a bandgap reference circuit of the present invention. The bandgap reference circuit includes a mirroring circuit 142, an operation amplifier 145 and an input circuit 150. The mirroring circuit 142 comprises three PMOS FETs, M1, M2 and M3. In this example, M1, M2 and M3 have the same aspect ratio (W/L), and the gates of M1, M2 and M3 are connected to one another and the sources of M1, M2 and M3 are connected to a supply voltage (Vss). The drains of M1, M2 and M3 output current Iₓ, I_{y} and I_{z} respectively. Also, an output terminal of the operation amplifier 145 is connected to the gates of M1, M2 and M3 while a positive input terminal of the operation amplifier 145 is connected to the drain of M2 and a negative input terminal of the operation amplifier 145 is connected to the drain of M1. Furthermore, input circuit 150 comprises two NMOS FETs, M4 and M5 and the threshold voltage of M4 is larger than that of M5 (Vₜₕ₄>Vₜₕ₅). A gate and a drain of M4 are connected to each other and a source of M4 is connected to the ground. The same, a gate and a drain of M5 are connected to each other and a source of M5 is connected to the ground. Furthermore, the drain of M5 is connected to the negative input terminal of the operation amplifier 145. A first resistor (R1) is connected between the drain of M4 and the positive of the operation amplifier 145. Furthermore, a second resistor (R2) is connected between the drain of M3 and the ground and the drain of M3 is capable of outputting the reference voltage (V_{ref}).

As shown in FIG. 6, since M1, M2 and M3 have the same aspect ratio, the current Iₓ, I_{y} and I_{z} outputted by the M1, M2 and M3 are the same. That is Iₓ=I_{y}=I_{z} - - - (16). Or, the values of output currents Iₓ, I_{y} and I_{z} may have a constant ratio relationship if the aspect ratio W/L of M1, M2, and M3 has a corresponding ratio.

Further, under the premise that the operation amplifier 145 has an infinite gain, a voltage difference between the positive and negative input terminals of the operation amplifier 45 will be the same. That is V_{y}=Vₓ. Thus, R₁I_{y}+V_{SG5}=V_{SG4} - - - (17), which can be written as I_{y}=(V_{SG4}−V_{SG5})/R₁=ΔV_{GS}/R₁.

Moreover, according to Eq. (13), when M4 and M5 are operating in the subthreshold region, the threshold-voltage-difference value (ΔV_{TH}(T)) is given by:

$$Δ {V}_{TH} ( T ) ≅ Δ {V}_{TH} ( {T}_{0} ) + Δ {K}_{T} ( \frac{T}{{T}_{0}} - 1 ) ,$$

where ΔKₜ<0.

According to Eq. (14), the gate-source voltage of M4 and M5 are given by:

$${V}_{GS 4} ( T ) ≅ {V}_{TH 4} ( T ) + {V}_{OFF 4} + [ {V}_{GS 4} ( {T}_{0} ) - {V}_{TH 4} ( {T}_{0} ) - {V}_{OFF 4} ] \frac{T}{{T}_{0}} , \qquad ( 18 )$$

and

$${V}_{GS 5} ( T ) ≅ {V}_{TH 5} ( T ) + {V}_{OFF 5} + [ {V}_{GS 5} ( {T}_{0} ) - {V}_{TH 5} ( {T}_{0} ) - {V}_{OFF 5} ] \frac{T}{{T}_{0}} . \qquad ( 19 )$$

Subtracting Eq. (19) from Eq. (18) can yield the expression:

$$Δ {V}_{GS} ( T ) ≅ [ Δ {V}_{TH} ( {T}_{0} ) + \vert Δ {K}_{T} \vert ] + [ Δ {V}_{GS} ( {T}_{0} ) + \vert Δ {V}_{OFF} \vert ] \cdot ( \frac{T}{{T}_{0}} ) - [ Δ {V}_{TH} ( {T}_{0} ) + \vert Δ {K}_{T} \vert ] \cdot ( \frac{T}{{T}_{0}} ) , \qquad ( 20 )$$

where ΔV_{GS}(T)=V_{GS4}(T)−V_{GS5}(T), ΔV_{TH}(T₀)=V_{TH4}(T₀)−V_{TH5}(T₀), ΔV_{GS}(T₀)=V_{GS4}(T₀)−V_{GS5}(T₀), and ΔV_{OFF}=V_{OFF4}−V_{OFF5}.

In Eq. (20), the first term [ΔV_{TH}(T₀)+|ΔK_{T}|] is a temperature-independent constant; the second term

$$+ [ Δ {V}_{GS} ( {T}_{0} ) + \vert Δ {V}_{OFF} \vert ] \cdot ( \frac{T}{{T}_{0}} )$$

is a positive-temperature coefficient; the third term

$$- [ Δ {V}_{TH} ( {T}_{0} ) + \vert Δ {K}_{T} \vert ] \cdot ( \frac{T}{{T}_{0}} )$$

is a negative-temperature coefficient. In other words, through a proper arrangement of the size of transistors (for example, channel length, channel width, or aspect ratio) and the values of the resistors in the bandgap reference circuit depicted in FIG. 6, a zero-temperature coefficient can be derived from the positive-temperature coefficient adding to the negative-temperature coefficient. That is, I_{y}=ΔV_{GS}/R₁ is independent of temperature, accordingly a temperature-independent reference voltage (V_{ref}) is given by:

$${V}_{ref} = \frac{{R}_{2}}{{R}_{1}} \cdot Δ {V}_{GS} .$$

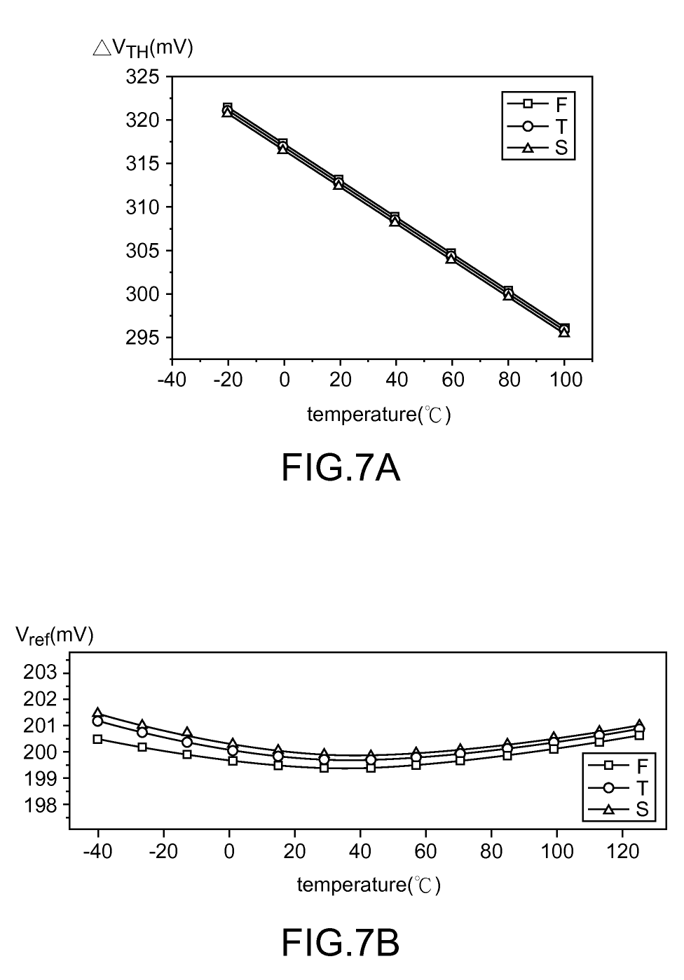

Furthermore, the reference voltage (V_{ref}) derived from the bandgap reference circuit of the present invention depicted in FIG. 6 is also independent of the deviation resulted in the standard semiconductor fabrication process. FIG. 7A is a diagram showing the threshold-voltage-difference value (ΔV_{TH}(T)) of two S-corner FETs, F-corner FETs, and T-corner FETs versus the temperature, where the S-corner FETs, the F-corner FETs, and the T-corner FETs have different threshold voltages V_{TH} due to the deviation resulted in the standard semiconductor fabrication process. Obviously, the threshold-voltage-difference value (ΔV_{TH}(T)) of the S-corner FET, the F-corner FET, and the T-corner FET have almost a same curve. In other words, the bandgap reference circuit of the present invention is implemented by a characteristic of: all the threshold-voltage-difference values (ΔV_{TH}(T)) of two S-corner FETs, F-corner FETs, or T-corner FETs have a same specific relationship with the temperature, no matter the S-corner FET, F-corner FET, and the T-corner FET have different threshold voltages resulted in the deviation of the semiconductor fabrication process. Two FETs having different threshold voltages can be manufactured through controlling the thickness of the silicon dioxide layer in the standard semiconductor fabrication process.

FIG. 7B is a diagram showing the reference voltage (V_{ref}) versus the temperature, where the reference voltage is derived from the bandgap reference circuit implemented by S-corner FETs, F-corner FETs, or T-corner FETs having different threshold voltages resulted in the deviation of the standard semiconductor fabrication process. The bias error of the reference voltage (V_{ref}) is about ±2%, which is almost can be neglected. In other words, the reference voltage (V_{ref}) derived from the bandgap reference circuit of the present invention is independent of temperature and the deviation resulted in the standard semiconductor fabrication process.

The present invention provides a bandgap reference circuit capable of operated at a relatively low supply voltage and the bandgap reference circuit can be manufactured in a standard semiconductor fabrication process. The bandgap reference circuit of the present invention is implemented through the threshold-voltage-difference value (ΔV_{TH}(T)) of transistors compensating the deviation resulted in the semiconductor fabrication process, and the bandgap reference circuit is almost independent of temperature and the deviation of the semiconductor fabrication process.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A bandgap reference circuit, comprising:
an input circuit having a first FET, a second FET, and a first resistor, wherein a first node is connected to the first FET having a first threshold voltage, the first resistor is connected between a second node and the second FET having a second threshold voltage;
a mirroring circuit, for controlling two output currents respectively derived from the first and second nodes, and maintaining the two output currents to a specific current ratio; and
an operation amplifier connected to the first node, the second node of the input circuit, and the mirroring circuit, for controlling two voltages respectively at the first and second nodes of the input circuit to a specific voltage ratio;
wherein the first FET and the second FET are both operating in the subthreshold region, the first threshold voltage is larger than the second threshold voltage, and the two output currents are independent of temperature.

2. The bandgap reference circuit according to claim 1, wherein both the first FET and the second FET are NMOS transistors, a gate and a drain of the first FET are connected to the first node, a source of the first FET is connected to a ground, a gate and a drain of the second FET are connected to the first resistor, a source of the second FET is connected to the ground.

3. The bandgap reference circuit according to claim 1, wherein the mirroring circuit can further output a third output current, and the third output current is proportional to the two output currents.

4. The bandgap reference circuit according to claim 3, wherein the third output current is capable of passing a second resistor for generating a reference voltage.

5. The bandgap reference circuit according to claim 1, wherein the first FET and the second FET have a different thickness of the silicon dioxide layer.

6. The bandgap reference circuit according to claim 1, wherein the mirroring circuit further comprises two PMOS transistors, gates of the two PMOS transistors are connected to each other, sources of the two PMOS transistors are connected to a supply voltage, drains of the two PMOS transistors are respectively connected to the first node and the second node.

7. The bandgap reference circuit according to claim 6, wherein an output terminal of the operation amplifier is connected to gates of the two PMOS transistors, two input terminals of the operation amplifier are respectively connected to the first node and the second node.

8. The bandgap reference circuit according to claim 6, wherein the specific current ratio is determined by the aspect ratios of the two PMOS transistors.

9. A bandgap reference circuit, comprising:
an input circuit having a first FET, a second FET, and a load device, wherein a first node is connected to a first FET having a first threshold voltage, the load device is connected between a second node and the second FET having a second threshold voltage;
a mirroring circuit; and
an operation amplifier connected to the mirroring circuit, for controlling the mirroring circuit according a voltage difference between the first node and the second node;
wherein the mirroring circuit is capable of generating two output currents respectively derived from the first node and the second node by control of the operation amplifier and maintaining the two output currents to a specific current ratio, and the first FET and the second FET are both operating in the subthreshold region, the first threshold voltage is greater than the second threshold voltage, and the two output currents are independent of temperature.

10. The bandgap reference circuit according to claim 9, wherein the load device is a resistor.
